(19) United States
(12) Patent Application Publication
(10) Pub. No.: US 2018/0052308 A1
(43) Pub. Date: Feb. 22, 2018

(54) OPTICAL LENS ACCESSORY FOR WIDE-ANGLE PHOTOGRAPHY

(71) Applicant: JRD COMMUNICATION INC., Shenzhen, Guangdong (CN)

(72) Inventors: Mei KONG, Shenzhen (CN); Zhe LIU, Shenzhen (CN)

(73) Assignee: JRD COMMUNICATION INC., Shenzhen, Guangdong (CN)

(21) Appl. No.: 15/542,651

(22) PCT Filed: Oct. 19, 2016
(86) PCT No.: PCT/CN2016/102614

§ 371 Date: Jul. 10, 2017

(30) Foreign Application Priority Data
Mar. 23, 2016 (CN) 201610169539.9

(51) Int. Cl. G02B 13/06; G03B 17/14; H04N 5/225; H04N 5/232; G03B 17/56

(52) U.S. Cl. CPC G02B 13/06; G03B 17/14; G03B 17/565; H04N 5/23238; H04N 5/2254

(57) ABSTRACT

An optical lens accessory for wide-angle photography is provided. The optical lens accessory includes: an optical device having a wide-angle lens. The optical device is configured to frame a view with a range of viewing angle greater than a range of viewing angle of the camera device and let framed light into the camera device; a housing device positioned outside the optical device and causing no interference to the range of viewing angle of the wide-angle lens, the housing device is configured to support the optical device, and to isolate the framed light from external stray light, thereby preventing the external stray light from interfering with an optical path of the framed light; and a fixture device configured to attach the optical lens accessory to the camera device of the terminal device while causing no interference to the range of viewing angle of the wide-angle lens.

### TECHNICAL FIELD

This disclosure relates generally to the field of photography, and more particularly, to an optical lens accessory for wide-angle photography.

### BACKGROUND

A wide-angle image is an image captured by a wide-angle lens. In brief, the shorter the focal length, the wider the field of view, and more surrounding objects can be accommodated in the image. On the other hand, the longer the focal length, the narrower the field of view, but distant objects can be photographed.

A panorama is a kind of wide-angle images. Panorama is expressed through a wide-angle view, as well as in the form of painting, photo, video, and 3D model etc., so as to display the surrounding environment as much as possible. A 360° panorama is achieved by capturing image information of an entire scene by a professional camera, or using images rendered by a modeling software; stitching the images by an image stitching software, and finally playing the 360° panorama on a specific player. That is to transform a two-dimensional image or an image rendered by computer modeling into a 360° panoramic view for a virtual reality view. The two-dimensional image may be simulated as a real three-dimensional space and presented to a viewer.

Currently, specialized image capturing devices are often required to capture a wide-angle image or a panorama, and the specialized image capturing devices are usually expensive. For example, when capturing a spherical panorama, an integrated capturing device is mainly used. The integrated capturing device may include one or more optical lenses, optical image sensors, motion detection sensors, image processing units, image storage modules, physical buttons, displays for output, rechargeable batteries, and wired or wireless connection modules that communicate with other devices. The price of such products may be too expensive that users may not afford.

### SUMMARY

A principal technical problem to be addressed by the disclosure is to provide an optical lens accessory for wide-angle photography, which can rapidly and easily meet the needs for wide-angle image capturing, thereby greatly reducing costs for users, and improving user experience.

To address the technical problem above, according to an aspect of the disclosure, an optical lens accessory for wide-angle photography is disclosed. The optical lens accessory is used in conjunction with a camera device of a terminal device equipped with at least one camera device, the optical lens accessory includes: an optical device including at least one wide-angle lens, wherein the optical device is configured to frame a view with a range of viewing angle greater than a range of viewing angle of the camera device and let framed light into the camera device; a housing device positioned outside the optical device and causing no interference to the range of viewing angle of the at least one wide-angle lens, wherein the housing device is configured to support the optical device, and to isolate the framed light from external stray light, thereby preventing the external stray light from interfering with an optical path of the framed light; and a fixture device configured to attach the optical lens accessory to the camera device of the terminal device while causing no interference to the range of viewing angle of the at least one wide-angle lens, thereby facilitating a cooperative use of the optical lens accessory with the camera device to perform wide angle-of-view photographing.

In some embodiments, the optical device includes: two fisheye lenses arranged in a back-to-back configuration, wherein directions of the two respective viewing angles associated with the two fisheye lenses are opposite to each other, and wherein the viewing angle of each of the two fisheye lenses is greater than 180° to allow each of the two fisheye lenses to independently frame a view in the respective direction of the respective viewing angle; and two first reflective elements respectively positioned in two optical paths through which the two framed lights entering the camera device, wherein the two first reflective elements are configured to reflect the two framed lights into two first reflective lights, respectively, and causing the two first reflective lights to enter the camera device.

In some embodiments, the optical device alternatively includes: two fisheye lenses arranged in a back-to-back configuration, wherein directions of the two respective viewing angles associated with the two fisheye lenses are opposite to each other, and wherein the viewing angle of each of the two fisheye lenses is greater than 180° to allow each of the two fisheye lenses to independently frame light in the respective direction of the respective viewing angle; two first reflective elements respectively positioned in two optical paths through which the two framed lights entering the camera device, wherein the two first reflective elements are configured to reflect the two framed lights into two first reflective lights, respectively, and causing the two first reflective lights to enter an optical path of the camera device; and a second reflective element positioned in the optical path through which the two first reflective lights entering the camera device, wherein the second reflective element is configured to reflect the two first reflective lights into two second reflective lights, respectively, and causing the two second reflective lights to enter the camera device.

In some embodiments, the optical device further comprises: a first lens positioned in the optical path through which the two first reflective lights entering the camera device, wherein the first lens is configured to move back and forth along an axial direction thereof to adjust a distance between the first lens and the camera device so as to merge the two first reflective lights, thereby causing the two first reflective lights to both enter the camera device.

In some embodiments, during the cooperative use of the optical lens accessory with the camera device, the two fisheye lenses are positioned on a left side and a right side of the camera device, respectively.

In some embodiments, the optical device further comprises: a second lens positioned in the optical path through which the two second reflective lights entering the camera device, wherein the second lens is configured to move back and forth along an axial direction thereof to adjust a distance between the second lens and the camera device so as to merge the two second reflective lights, thereby causing the two second reflective lights to both enter the camera device.

In some embodiments, during the cooperative use of the optical lens accessory with the camera device, the two fisheye lenses are positioned on a front side and a rear side of the camera device, respectively.

In some embodiments, the two first reflective elements are perpendicular to each other and an angle between an incident light plane of each of the two first reflective elements and the framed light of each of the associated fisheye lens is 45 degrees, thereby facilitating reflecting the two paths of the framed lights into two parallel paths of the two first reflective lights, respectively.

In some embodiments, the centers of the two fisheye lenses are located on a same axis.

In some embodiments, a distance between the two fisheye lenses is defined as a first distance, wherein when the optical lens accessory is attached to the adapted terminal device, the first distance is such that an area associated with a portion of the viewing-angle-covered field blocked by the terminal device is minimized.

In some embodiments, a size of the housing device is defined as a first size, wherein when the optical lens accessory is attached to the adapted terminal device, the first size is such that an area associated with a portion of the viewing-angle-covered field blocked by the terminal device is minimized.

To address the technical problem above, according to another aspect of the disclosure, an optical lens accessory for wide-angle photography is disclosed. The optical lens accessory is used in conjunction with a terminal device equipped with at least one camera device, the optical lens accessory includes: an optical device including at least one wide-angle lens, wherein the optical device is configured to frame a view with a range of viewing angle greater than a range of viewing angle of the at least one camera device and let framed light into the at least one camera device; a housing device positioned outside the optical device and causing no interference to the range of viewing angle of the at least one wide-angle lens, wherein the housing device is configured to support the optical device, and to isolate the framed light from external stray light, thereby preventing the external stray light from interfering with an optical path of the framed light; and a fixture device configured to attach the optical lens accessory to the at least one camera device of the terminal device while causing no interference to the range of viewing angle of the at least one wide-angle lens, thereby facilitating a cooperative use of the optical lens accessory with the at least one camera device to perform wide angle-of-view photographing.

In some embodiments, the optical lens accessory is used in conjunction with one of the camera devices of the terminal device.

In some embodiments, the optical device further comprises: two fisheye lenses arranged in a back-to-back configuration, wherein the directions of the two respective viewing angles associated with the two fisheye lenses are opposite to each other, and wherein the viewing angle of each of the two fisheye lenses is greater than 180° to allow each of the two fisheye lenses to independently frame a view in the respective direction of the respective viewing angle; and two first reflective elements respectively positioned in two optical paths through which the two framed lights entering the one camera device, wherein the two first reflective elements are configured to reflect the two framed lights into two first reflective lights, respectively, and causing the two first reflective lights to enter the one camera device.

In some embodiments, the optical device further comprises: a first lens positioned in the optical path through which the two first reflective lights entering the one camera device, wherein the first lens is configured to move back and forth along an axial direction thereof to adjust a distance between the first lens and the one camera device so as to merge the two first reflective lights, thereby causing the two first reflective lights to both enter the one camera device.

In some embodiments, during the cooperative use of the optical lens accessory with the one camera device, the two fisheye lenses are positioned on a left side and a right side of the one camera device, respectively.

In some embodiments, the optical device further comprises: two fisheye lenses arranged in a back-to-back configuration, wherein the directions of the two respective viewing angles associated with the two fisheye lenses are opposite to each other, and wherein the viewing angle of each of the two fisheye lenses is greater than 180° to allow each of the two fisheye lenses to independently frame light in the respective direction of the respective viewing angle; two first reflective elements respectively positioned in two optical paths through which the two framed lights entering the one camera device, wherein the two first reflective elements are configured to reflect the two framed lights into two first reflective lights, respectively, and causing the two first reflective lights to enter an optical path of the one camera device; and a second reflective element positioned in the optical path through which the two first reflective lights entering the one camera device, wherein the second reflective element is configured to reflect the two first reflective lights into two second reflective lights, respectively, and causing the two second reflective lights to enter the one camera device.

In some embodiments, the optical device further comprises: a second lens positioned in the optical path through which the two second reflective lights entering the one camera device, wherein the second lens is configured to move back and forth along an axial direction thereof to adjust a distance between the second lens and the one camera device so as to merge the two second reflective lights, thereby causing the two second reflective lights to both enter the one camera device.

In some embodiments, during the cooperative use of the optical lens accessory with the one camera device, the two fisheye lenses are positioned on a front side and a rear side of the one camera device, respectively.

In some embodiments, the two first reflective elements are perpendicular to each other and an angle between an incident light plane of each of the two first reflective elements and the framed light of each of the associated fisheye lens is 45 degrees, thereby facilitating reflecting the two paths of the framed lights into two parallel paths of the two first reflective lights, respectively.

In some embodiments, centers of the two fisheye lenses are located on a same axis.

In some embodiments, a distance between the two fisheye lenses is defined as a first distance, wherein when the optical lens accessory is attached to the adapted terminal device, the first distance is such that an area associated with a portion of the viewing-angle-covered field blocked by the terminal device is minimized.

In some embodiments, a size of the housing device is defined as a first size, wherein when the optical lens accessory is attached to the adapted terminal device, the first size is such that an area associated with a portion of the viewing-angle-covered field blocked by the terminal device is minimized.

Advantages of the disclosure may follow. As compared with the prior art, the optical lens accessory of the present disclosure is used in conjunction with a terminal device equipped with at least one camera device, the optical lens accessory includes: an optical device including at least one wide-angle lens. The optical device is configured to frame a view with a range of viewing angle greater than a range of viewing angle of the camera device and let framed light into the camera device; a housing device positioned outside the optical device and causing no interference to the range of viewing angle of the at least one wide-angle lens, wherein the housing device is configured to support the optical device, and to isolate the framed light from external stray light, thereby preventing the external stray light from interfering with the optical path of the framed light; and a fixture device configured to attach the optical lens accessory to the camera device of the terminal device while causing no interference to the range of viewing angle of the at least one wide-angle lens, thereby facilitating a cooperative use of the optical lens accessory with the camera device to perform wide angle-of-view photographing. Given that the optical lens accessory is used in conjunction with a terminal device equipped with at least one camera device, the optical lens accessory includes a wide-angle lens, the wide-angle lens is configured to frame a view with a range of viewing angle greater than a range of viewing angle of the camera device and let framed light into the camera device. By this configuration, the present technology can rapidly and easily meet the needs for wide-angle photography with the terminal device equipped with the camera device, thereby greatly reducing costs for users, and improving user experience.

### BRIEF DESCRIPTION OF THE DRAWINGS

FIG. 1 is a block diagram of an exemplary system based on an optical lens accessory and a terminal device with a camera device according to one embodiment of the present disclosure.

FIG. 2 is a block diagram of an optical lens accessory for wide-angle photography according to one embodiment of the present disclosure.

FIG. 3 is a block diagram of an optical lens accessory for wide-angle photography according to another embodiment of the present disclosure.

FIG. 4 is a block diagram of an optical lens accessory for wide-angle photography according to yet one embodiment of the present disclosure.

FIG. 5 is an exemplary image generated by an optical image sensor of the exemplary system shown in FIG. 2 according to one embodiment of the present disclosure.

FIG. 6 is an exemplary image generated by an optical image sensor of the exemplary system shown in FIG. 4 according to one embodiment of the present disclosure.

### DETAILED DESCRIPTION

The detailed description set forth below is intended as a description of the subject technology with reference to the appended figures and embodiments.

The present disclosure may be based on a fact that most common mobile terminals, such as smart phones and tablets may include components and modules for capturing wide-angle images or used in panoramic imaging devices. The present disclosure may reuse the existing components and modules, and add one or more missing components, for example, including an optical lens accessory to project a wide-angle image or a panoramic image to a camera device on a terminal.

Turning to FIG. 1, a block diagram of an exemplary system based on an optical lens accessory and a terminal device with a camera device according to one embodiment of the present disclosure is shown. The exemplary system includes an optical lens accessory 100 and a terminal device 200 with a camera device 21.

The optical lens accessory 100 may be configured to frame a view with a range of viewing angle greater than a range of viewing angle of the camera device 21, and let framed light into the camera device 21 in the terminal device 200. The optical lens accessory 100 may include an optical device 1, a housing device 2, and a fixture device 3.

The optical device 1 may include at least one wide-angle lens to frame a view with a range of viewing angle greater than a range of viewing angle of the camera device 21 and let framed light into the camera device 21. The housing device 2 may be positioned outside the optical device 1. In some aspects, the housing device 2 may cause no interference to the range of viewing angle of the at least one wide-angle lens. The housing device 2 is configured to support the optical device, and to isolate the framed light from external stray light, thereby preventing the external stray light from interfering with an optical path of the framed light. The fixture device 3 may be configured to attach the optical lens accessory 100 to the camera device 21 of the terminal device 200 while causing no interference to the range of viewing angle of the at least one wide-angle lens, thereby facilitating a cooperative use of optical lens accessory 100 with the camera device 21 to perform wide angle-of-view photographing.

The camera device 21 of the terminal device 200 may capture image content with a wide-angle view. The camera device 21 may include an optical capture module 211, an optical adaptation and image processing module 212. The optical capture module 211 may be a part of terminal device 200, and may generally relate to a camera device (e.g., camera lens and optical image sensor) that processes and records one or more wide-angle images. A display of the terminal may display the one or more wide-angle images. One or more sensors (e.g., Accelerometers and Gyroscopes) may be used to perform calibration to reduce imaging jitters caused by imaging capturing process.

The optical adaptation and image processing module 212 may be related to the following descriptions. As described above, the optical lens accessory 100 is mounted on the camera device of the terminal device 200 to capture one or more images. The camera device of the terminal device 200 may produce one or more images captured by the optical lens accessory 100 through an optical image sensor, and perform image stitching, and image post-processing by a computer software.

The detailed description of the optical lens accessory 100 is as follows.

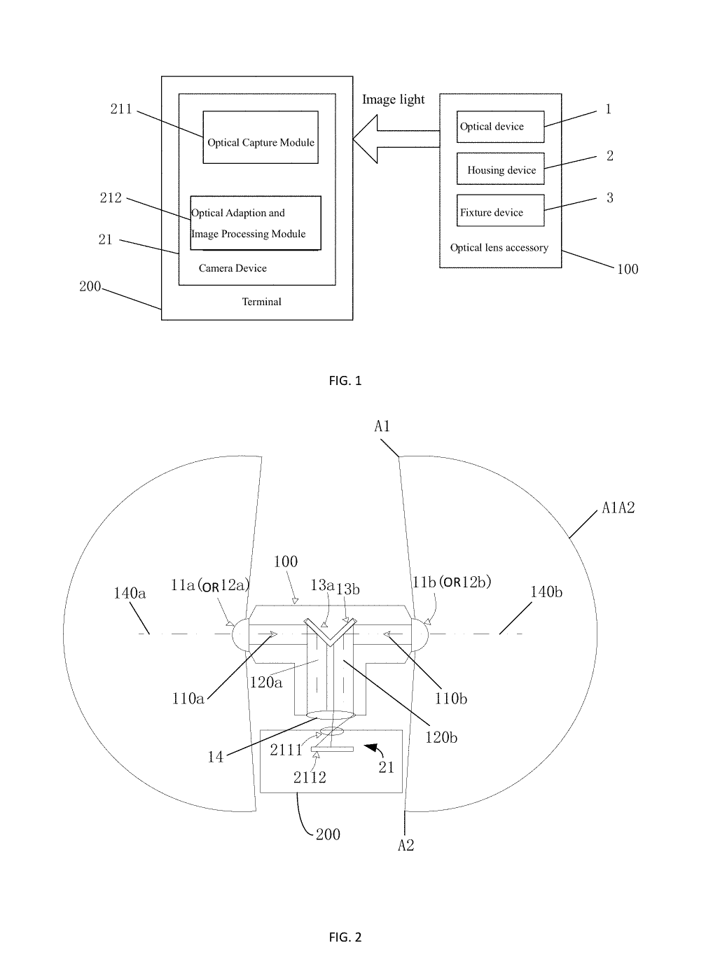

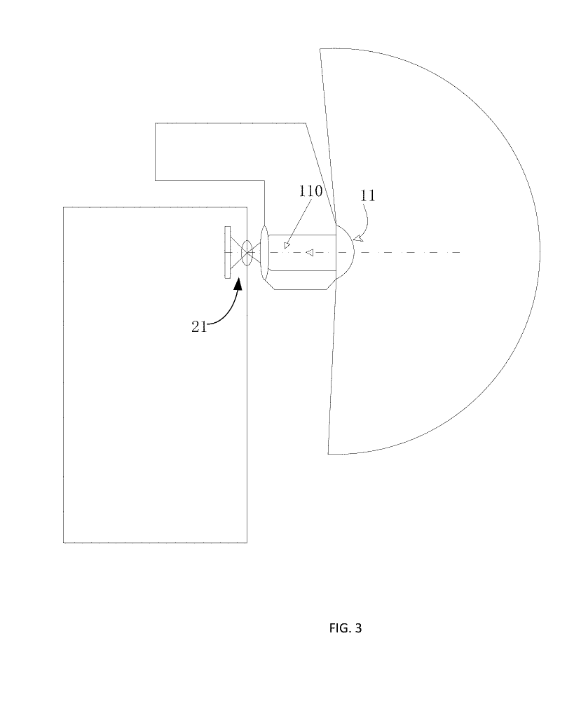

Turning to FIG. 2, the present disclosure provides an optical lens accessory for wide-angle photography. The optical lens accessory 100 may be used in conjugation with the terminal device 200 equipped with at least one camera device 21. Existing terminal devices equipped with at least one camera device may include smart phones, tablet computers and cameras.

The optical lens accessory 100 may include an optical device, a housing device, and a fixture device. The optical device may include at least one wide-angle lens. The optical device may be configured to frame a view with a range of viewing angle greater than a range of viewing angle of the camera device 21 (e.g., arc A1A2 formed by connecting point A1 and point A2) and let framed light 110 (e.g., 110a, 110b) into the camera device 21.

When the optical lens accessory 100 is used in conjunction with one camera device 21 of the terminal device 200 (e.g., a rear camera of a mobile phone), one or more wide-angle images may be captured by using only one wide-angle lens and one or more images with a wider angle may be captured, such as panoramic images, by using two wide-angle lenses. When the optical lens accessory 100 is used in conjunction with two camera devices 21 of the terminal device 200 (e.g., a front camera and a rear camera of a mobile phone), one or more images with a wider angle may be captured, such as panoramic images, by using two wide-angle lenses. When terminal device 200 includes two or more camera devices 21, one or more images with a wider angle may be captured, such as panoramic images, by using two wide-angle lenses.

If the center of wide-angle lens 11 and the center of camera device 21 are located on a same axis, the framed light 110 from a wide-angle lens can be let directly into the camera device 21. As shown in FIG. 3, an optical device may include a wide-angle lens 11 with the center of wide-angle lens 11 and the center of camera device 21 located on a same axis, thus the framed light 110 from wide-angle lens 11 can be let directly into the camera device 21. If the center of wide-angle lens 11 and the center of camera device 21 are not located on a same axis, framed light can be reflected by a reflective element and let into the camera device 21.

As shown in FIG. 2, the optical device may include two wide-angle lenses 11, and the center of each of two wide-angle lenses 11 and the center of camera device 21 are not located on a same axis. In the present embodiment, the center of each of two wide-angle lens 11 is located on a same axis and the center of each of the two wide-angle lenses 11 is perpendicular to the center of camera device 21. Framed light can be reflected by one or more reflective elements (e.g., two reflective elements in FIG. 2) and let into camera device 21.

Certainly, the wide-angle lens 11 may include one or more additional optical lenses to facilitate transmission of one or more optical paths. For example, the framed light 110 coming out of the wide-angle lens 11 may be parallel to external stray light getting into the wide-angle lens 11. Subsequently, the framed light 110 from wide-angle lens 11 can enter into the camera device 21 more easily.

In addition, to focus the light that entered into the camera device 21 to an image by a spherical view angle, the camera device 21 may be configured to set one or more optical lenses in an optical path entering into the camera device 21.

Thus, designs and configurations of the optical device may be adjusted based on the actual application and mounting requirements.

The housing device is positioned outside the optical device and causes no interference to the range of viewing angle of wide-angle lens 11. The housing device may be configured to support the optical device, and to isolate the framed light 110 from external stray light, thereby preventing the external stray light from interfering with the optical path of the framed light 110.

The fixture device may be configured to attach the optical lens accessory 100 to the terminal device 200 while causing no interference to the range of viewing angle of wide-angle lens 11, thereby facilitating a cooperative use of the optical lens accessory 100 with the camera device 21 to perform wide angle-of-view photographing.

In order to maximize the patency of image with a viewing angle, the housing device of the optical lens accessory 100 may satisfy a design rule that the housing device may cause no interference to the range of viewing angle of the wide-angle lens 11 and be located outside of the range of viewing angle of the wide-angle lens 11. Similarly, the fixture device may satisfy the same design rule.

In addition, the optical lens accessory 100 may be designed in an asymmetrical shape so as to better accommodate the shape of the terminal device.

It is noted that the details of mounting the optical lens accessory 100 onto the terminal device may not be limited herein. The detailed requirements for mounting the optical lens accessory 100 may include fitting optical lens accessory 100 and the camera device 21 of the terminal device 200 nicely and tightly, generating a very small offset between the central position of the optical lens accessory 100 and the central position of the camera device 21 (e.g., preferably, no offset). Thus, if there is an interactive, compatible structural designed between the terminal device 200 (e.g., designed in a convex shape) and the optical lens accessory (e.g., designed in a concave shape), it will greatly facilitate installation, thus allowing faster attaching, positioning, and removing of the optical lens accessory 100.

The optical lens accessory of the present disclosure is used in conjunction with a terminal device equipped with at least one camera device, the optical lens accessory includes: an optical device including at least one wide-angle lens. The optical device is configured to frame a view with a range of viewing angle greater than a range of viewing angle of the camera device and let framed light into the camera device; a housing device positioned outside the optical device and causing no interference to the range of viewing angle of the at least one wide-angle lens, wherein the housing device is configured to support the optical device, and to isolate the framed light from external stray light, thereby preventing the external stray light from interfering with the optical path of the framed light; and a fixture device configured to attach the optical lens accessory to the camera device of the terminal device while causing no interference to the range of viewing angle of the at least one wide-angle lens, thereby facilitating a cooperative use of the optical lens accessory with the camera device to perform wide angle-of-view photographing. Given that the optical lens accessory is used in conjunction with a terminal device equipped with at least one camera device, the optical lens accessory includes a wide-angle lens, the wide-angle lens is configured to frame a view with a range of viewing angle greater than a range of viewing angle of the camera device and let framed light into the camera device. By this configuration, the present technology can rapidly and easily meet the needs for wide-angle photography with the terminal device equipped with the camera device, thereby greatly reducing costs for users, and improving user experience.

The optical lens accessory 100 can be used in conjugation with one of the camera devices 21 of the terminal 200. For example, optical lens accessory 100 may be used in conjugation with rear camera 21 of the terminal device 200.

Turning to FIG. 2, the optical device includes: two fisheye lenses 12 (12a and 12b) and two first reflecting elements 13 (13a and 13b).

Two fisheye lenses 12 may be arranged in a back-to-back configuration, the directions of the two respective viewing angles associated with each of two fisheye lenses 12 are opposite to each other, and the viewing angle of each of two fisheye lenses 12 is greater than 180° to allow each of two fisheye lenses 12 to independently frame light in the respective direction of the respective viewing angle. Therefore, a viewing angle produced by the respective viewing angle of two fisheye lenses 12 can effectively and seamlessly cover a 360° spherical panoramic angle of view.

Two fisheye lenses 12 may be arranged in a back-to-back configuration, the directions of the two respective viewing angles associated with each of two fisheye lenses 12 are opposite to each other.

In theory, the centers of the two fisheye lenses 12 can be located on a same axis. Certainly, fisheye lenses 12 may include one or more additional optical lenses to facilitate transmission of one or more optical paths. For example, the framed light 110 passed through two fisheye lenses 12 may be parallel to external stray light passed through two fisheye lenses 12. Subsequently, the framed light 110 from wide-angle lens 11 can be let into camera device 21 more easily.

Two first reflective elements 13 may be respectively positioned in two optical paths through which the two framed lights 110 entering the camera device 21. Two first reflective elements 13 may be configured to reflect the two framed lights 110 into two first reflective lights 120 (e.g., 120a and 120b), respectively, and letting two first reflective lights 120 entering into camera device 21.

During the cooperative use of optical lens accessory 100 with camera device 21, two fisheye lenses 12 may be positioned on a left side and a right side of camera device 21, respectively (e.g., a left side and a right side of a mobile phone).

In addition, to focus framed light that entered into the camera device 21 to an image by a spherical view angle, before the framed light entering into camera device 21, the camera device 21 may be configured to set one or more optical lenses in an optical path entering into camera device 21.

As shown in FIG. 2, the optical device 1 may include a first lens 14. The first lens 14 may be positioned in two optical paths through which the two first reflective lights 120 entering camera device 21, and may be configured to move back and forth along an axial direction thereof to adjust a distance to the camera device 21 so as to merge the two first reflective lights 120 from the two associated optical paths, thereby causing the two first reflective lights from the two associated optical paths to both enter the camera device 21. User may adjust the location and distance between the first lens 14 and camera lens 213 of terminal device 200, so as to effectively control output image magnification on an optical image sensor 2112 on camera device 21.

According to another aspect of the disclosure, the optical device may have another configuration. Turning to FIG. 4, the optical device 1 may include: two fisheye lenses 12 (12a and 12b), two first reflective elements 13 (13a and 13b), and a second reflective element 15.

Two fisheye lenses 12 may be arranged in a back-to-back configuration, where the directions of the two respective viewing angles associated with the two fisheye lenses are opposite to each other, and wherein the viewing angle of each of two fisheye lenses 12 is greater than 180° to allow each of the two fisheye lenses to independently frame light in the respective direction of the respective viewing angle. Two first reflective elements 13 may be respectively positioned in two optical paths through which two framed lights 110 (110a and 110b) entering the camera device 21, where the two first reflective elements 13 may be configured to reflect the two framed lights 110 into two first reflective lights 120, respectively, and causing the two first reflective lights 120 (120a and 120b) to enter the two optical paths of camera device 21. The second reflective element 15 may be positioned in the two optical paths of the two first reflective lights 120 entering the camera device, where the second reflective elements may be configured to reflect the two first reflective lights into two second reflective lights 130 (130a and 130b), respectively, and causing the two second reflective lights 130 to enter the camera device 21.

During the cooperative use of the optical lens accessory 100 with the camera device 21, two fisheye lenses 12 may be positioned on a front side and a rear side of the camera device 21, respectively (e.g., a front side and a rear side of a mobile phone).

In addition, to focus framed light that entered into the camera device 21 to an image by a spherical view angle, before the framed light entering into the camera device 21, the camera device 21 may be configured to set one or more optical lenses in an optical path entering into camera device 21.

As shown in FIG. 4, additionally, optical device may include a second lens 16. The second lens 16 may be positioned in two optical paths through which two second reflective lights 130 entering camera device 21, and may be configured to move back and forth along an axial direction thereof to adjust a distance to the camera device 21 so as to merge two second reflective lights 130 from the two associated optical paths, thereby causing two second reflective lights 130 from the two associated optical paths to both enter the camera device 21.

Additionally, two first reflective elements 13 may be perpendicular to each other and an angle between an incident light plane of each of the two first reflective elements and framed light 110 of each of the associated fisheye lens is 45 degrees, thereby facilitating reflecting two paths of the framed lights 110 into two parallel paths of the two first reflective lights, respectively. The first reflective element 13 may be a reflecting prism.

The centers of two fisheye lenses 12 may be located on a same axis. By this way, a more compact design of optical lens accessory may be achieved.

In some aspects, a distance between each of two fisheye lenses 12 may be defined as a first distance. When optical lens accessory 100 is attached to the adapted terminal device 200, the first distance is such that an area associated with a portion of the viewing-angle-covered field blocked by the terminal device is minimized.

In some aspects, a size of housing device 2 is defined as a first size. When the optical lens accessory 100 is attached to the adapted terminal device 200, the first size is such that an area associated with a portion of the viewing-angle-covered field blocked by the terminal device 200 is minimized.

The requirements as described above may be based on a consideration of the size of the terminal device 200, the location of the camera device 21, and the viewing angle of the fisheye lenses 12. The distance between housing device of optical lens accessory 100 and two fisheye lenses 12 may satisfy another design rule: an area associated with a portion of the viewing-angle-covered field blocked by the terminal device my need to be minimized.

Referring to FIG. 2, the detailed description of the change of optical path is described as below.

Referring to FIG. 2 and FIG. 4, the framed lights 110a and 110b from the fisheye lenses 12 (12a and 12b) may be parallel to lights 140a and 140b that entered the fisheye lenses 12 externally. The framed lights 110a and 110b may be then reflected by first reflective elements (e.g., reflective prisms) 13a and 13b into first reflective lights 120a and 120b. By this way, image lights captured by front and rear fisheye lenses 12 (12a and 12b) may be parallel and may converge into two new lights 120a and 120b, with the two new lights containing image information captured by two fisheye lenses 12. The converged new lights 120a and 120b may be reflected by the first lens 14 (e.g., as shown in FIG. 4: the converged new lights 120a and 120b may be reflected by the second reflective element 15 into two second reflective lights 130 (130a and 130b), respectively, the second reflective lights 130a and 130b may be emitted by second lens 16), and then projected onto optical image sensor 2112 through camera lens 2111 of camera device 21 of terminal device 200.

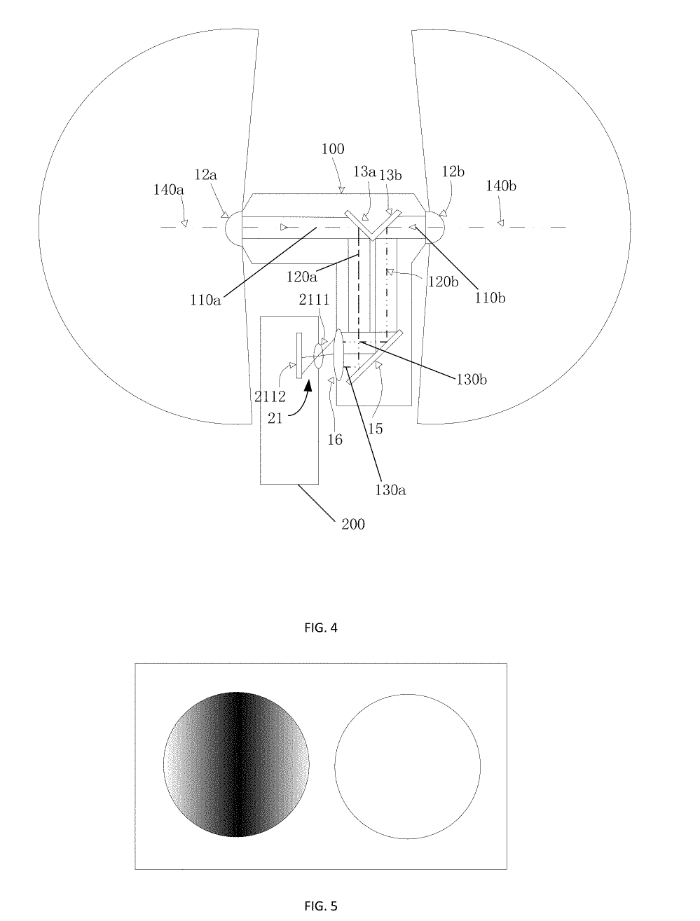

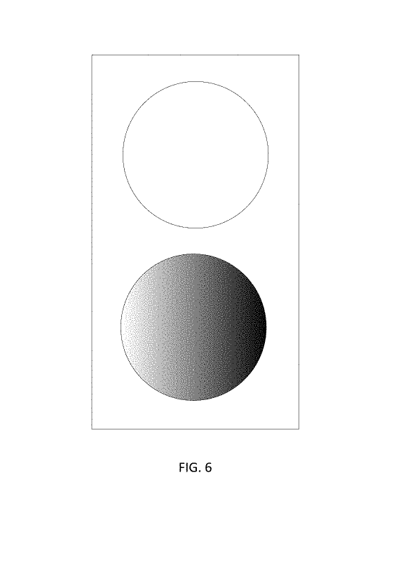

Referring to FIG. 5 and FIG. 6, images as shown may correspond to images generated by the optical image sensor in the system described in FIG. 2 and FIG. 4, respectively. The images may contain images of two hemispheres, each of the two hemispheres may correspond to the range of viewing angle of the two fisheye lenses. If the terminal device 200 includes a display, a user may view directly the viewable image content output by optical image sensor 214. As shown in FIG. 5 and FIG. 6, the user may manually adjust the position of optical lens accessory 100 attaching to the terminal 200, based on the viewable image content. Preferably, the ideal position of the optical lens accessory 100 attaching to terminal 200 may be based on images of the two hemispheres visible in entirely, not being cut, and symmetrically distributed.

The user may also adjust the position and distance between lens 14 or 16 of the optical lens accessory 100 and the camera lens 2111 of the camera device 21 of the terminal device 200 so that the output image magnification of the optical image sensor 214 of the camera device 21 can be effectively controlled.

If the terminal device 200 with image capturing capabilities contains one or more motion sensors such as a gyroscope and an accelerometer, data collected by the one or more motion sensors can effectively reduce one or more jitters resulting from the imaging capturing process.

As shown in FIG. 4, the main difference between this embodiment and that of FIG. 2 may be that a center axis of two fisheye lenses 12a and 12b of optical lens accessory 100 is in the same direction as the central axis of camera lens 213 of the terminal device 200. A typical application scenario may include attaching optical lens accessory 100 onto the top of a mobile phone or tablet computer. While being more complex, it may greatly reduce a portion of the viewing-angle-covered field blocked by terminal device 200 due to its physical size. Taking a mobile phone as example, FIG. 2 shows fisheye lenses 12 placed on the left and right sides of the mobile phone; FIG. 4 shows fisheye lenses 12 placed on the top of the mobile phone and on the front and rear sides of the phone.

In summary, the optical lens accessory of the present disclosure may have the following advantages:
(1) As compared with the prior art, the greatest advantage of the present disclosure may include simplifying one or more electronic circuits and components designs of the product. A simple adaptor comprising of the optical and structural modules may be a replacement, which has a low cost so that the users may capture one or more wide-angle images, spherical panoramic image with less cost and in a more convenient way.
(2) The scheme of the present disclosure may be universal. By changing the structure of housing and the number and position of the optical fisheye lenses, the optical lens accessory may be adapted in various circumstances.
(3) The present disclosure may have different applications and a promising market prospect.

It is understood that the descriptions above are only embodiments of the present disclosure. It is not intended to limit the scope of the present disclosure. Any equivalent transformation in structure and/or in scheme referring to the instruction and the accompanying drawings of the present disclosure, and direct or indirect application in other related technical field, are included within the scope of the present disclosure.

1. An optical lens accessory for wide-angle photography, wherein the optical lens accessory is used in conjunction with a camera device of a terminal device equipped with at least one camera device, the optical lens accessory comprises:
an optical device comprising at least one wide-angle lens, wherein the optical device is configured to frame a view with a range of viewing angle greater than a range of viewing angle of the camera device and let framed light into the camera device;
a housing device positioned outside the optical device and causing no interference to the range of viewing angle of the at least one wide-angle lens, wherein the housing device is configured to support the optical device, and to isolate the framed light from external stray light, thereby preventing the external stray light from interfering with an optical path of the framed light; and
a fixture device configured to attach the optical lens accessory to the camera device of the terminal device while causing no interference to the range of viewing angle of the at least one wide-angle lens, thereby facilitating a cooperative use of the optical lens accessory with the camera device to perform wide angle-of-view photographing,
wherein the optical device comprises:
two fisheye lenses arranged in a back-to-back configuration, wherein directions of the two respective viewing angles associated with the two fisheye lenses are opposite to each other, and wherein the viewing angle of each of the two fisheye lenses is greater than 180° to allow each of the two fisheye lenses to independently frame a view in the respective direction of the respective viewing angle; and
two first reflective elements respectively positioned in two optical paths through which the two framed lights entering the camera device, wherein the two first reflective elements are configured to reflect the two framed lights into two first reflective lights, respectively, and causing the two first reflective lights to enter the camera device; or
wherein the optical device comprises:
two fisheye lenses arranged in a back-to-back configuration, wherein directions of the two respective viewing angles associated with the two fisheye lenses are opposite to each other, and wherein the viewing angle of each of the two fisheye lenses is greater than 180° to allow each of the two fisheye lenses to independently frame light in the respective direction of the respective viewing angle;
two first reflective elements respectively positioned in two optical paths through which the two framed lights entering the camera device, wherein the two first reflective elements are configured to reflect the two framed lights into two first reflective lights, respectively, and causing the two first reflective lights to enter an optical path of the camera device; and
a second reflective element positioned in the optical path through which the two first reflective lights entering the camera device, wherein the second reflective element is configured to reflect the two first reflective lights into two second reflective lights, respectively, and causing the two second reflective lights to enter the camera device.

2. The optical lens accessory according to claim 1, wherein the optical device further comprises:
a first lens positioned in the optical path through which the two first reflective lights entering the camera device, wherein the first lens is configured to move back and forth along an axial direction thereof to adjust a distance between the first lens and the camera device so as to merge the two first reflective lights, thereby causing the two first reflective lights to both enter the camera device.

3. The optical lens accessory according to claim 1, wherein during the cooperative use of the optical lens accessory with the camera device, the two fisheye lenses are positioned on a left side and a right side of the camera device, respectively.

4. The optical lens accessory according to claim 1, wherein the optical device further comprises:
a second lens positioned in the optical path through which the two second reflective lights entering the camera device, wherein the second lens is configured to move back and forth along an axial direction thereof to adjust a distance between the second lens and the camera device so as to merge the two second reflective lights, thereby causing the two second reflective lights to both enter the camera device.

5. The optical lens accessory according to claim 1, wherein during the cooperative use of the optical lens accessory with the camera device, the two fisheye lenses are positioned on a front side and a rear side of the camera device, respectively.

6. The optical lens accessory according to claim 1, wherein the two first reflective elements are perpendicular to each other and an angle between an incident light plane of each of the two first reflective elements and the framed light of each of the associated fisheye lens is 45 degrees, thereby facilitating reflecting the two paths of the framed lights into two parallel paths of the two first reflective lights, respectively.

7. The optical lens accessory according to claim 1, wherein the centers of the two fisheye lenses are located on a same axis.

8. The optical lens accessory according to claim 1, wherein a distance between the two fisheye lenses is defined as a first distance, wherein when the optical lens accessory is attached to the adapted terminal device, the first distance is such that an area associated with a portion of the viewing-angle-covered field blocked by the terminal device is minimized.

9. The optical lens accessory according to claim 1, wherein a size of the housing device is defined as a first size, wherein when the optical lens accessory is attached to the adapted terminal device, the first size is such that an area associated with a portion of the viewing-angle-covered field blocked by the terminal device is minimized.

10. An optical lens accessory for wide-angle photography, wherein the optical lens accessory is used in conjunction with a terminal device equipped with at least one camera device, the optical lens accessory comprises:
an optical device comprising at least one wide-angle lens, wherein the optical device is configured to frame a view with a range of viewing angle greater than a range of viewing angle of the at least one camera device and let framed light into the at least one camera device;
a housing device positioned outside the optical device and causing no interference to the range of viewing angle of the at least one wide-angle lens, wherein the housing device is configured to support the optical device, and to isolate the framed light from external stray light, thereby preventing the external stray light from interfering with an optical path of the framed light; and
a fixture device configured to attach the optical lens accessory to the at least one camera device of the terminal device while causing no interference to the range of viewing angle of the at least one wide-angle lens, thereby facilitating a cooperative use of the optical lens accessory with the at least one camera device to perform wide angle-of-view photographing.

11. The optical lens accessory according to claim 10, wherein the at least one camera device comprises a plurality of camera devices, the optical lens accessory is used in conjunction with one of the camera devices of the terminal device.

12. The optical lens accessory according to claim 11, wherein the optical device further comprises:
two fisheye lenses arranged in a back-to-back configuration, wherein the directions of the two respective viewing angles associated with the two fisheye lenses are opposite to each other, and wherein the viewing angle of each of the two fisheye lenses is greater than 180° to allow each of the two fisheye lenses to independently frame a view in the respective direction of the respective viewing angle; and
two first reflective elements respectively positioned in two optical paths through which the two framed lights entering the one camera device, wherein the two first reflective elements are configured to reflect the two framed lights into two first reflective lights, respectively, and causing the two first reflective lights to enter the one camera device.

13. The optical lens accessory according to claim 12, wherein the optical device further comprises:
a first lens positioned in the optical path through which the two first reflective lights entering the one camera device, wherein the first lens is configured to move back and forth along an axial direction thereof to adjust a distance between the first lens and the one camera device so as to merge the two first reflective lights, thereby causing the two first reflective lights to both enter the one camera device.

14. The optical lens accessory according to claim 12, wherein during the cooperative use of the optical lens accessory with the one camera device, the two fisheye lenses are positioned on a left side and a right side of the one camera device, respectively.

15. The optical lens accessory according to claim 11, wherein the optical device further comprises:
two fisheye lenses arranged in a back-to-back configuration, wherein the directions of the two respective viewing angles associated with the two fisheye lenses are opposite to each other, and wherein the viewing angle of each of the two fisheye lenses is greater than 180° to allow each of the two fisheye lenses to independently frame light in the respective direction of the respective viewing angle;
two first reflective elements respectively positioned in two optical paths through which the two framed lights entering the one camera device, wherein the two first reflective elements are configured to reflect the two framed lights into two first reflective lights, respectively, and causing the two first reflective lights to enter an optical path of the one camera device; and
a second reflective element positioned in the optical path through which the two first reflective lights entering the one camera device, wherein the second reflective element is configured to reflect the two first reflective lights into two second reflective lights, respectively, and causing the two second reflective lights to enter the one camera device.

16. The optical lens accessory according to claim 15, wherein the optical device further comprises:
a second lens positioned in the optical path through which the two second reflective lights entering the one camera device, wherein the second lens is configured to move back and forth along an axial direction thereof to adjust a distance between the second lens and the one camera device so as to merge the two second reflective lights, thereby causing the two second reflective lights to both enter the one camera device.

17. The optical lens accessory according to claim 15, wherein during the cooperative use of the optical lens accessory with the one camera device, the two fisheye lenses are positioned on a front side and a rear side of the one camera device, respectively.

18. The optical lens accessory according to claim 12, wherein the two first reflective elements are perpendicular to each other and an angle between an incident light plane of each of the two first reflective elements and the framed light of each of the associated fisheye lens is 45 degrees, thereby facilitating reflecting the two paths of the framed lights into two parallel paths of the two first reflective lights, respectively.

19. The optical lens accessory according to claim 12, wherein centers of the two fisheye lenses are located on a same axis.

20. The optical lens accessory according to claim 12, wherein a distance between the two fisheye lenses is defined as a first distance, wherein when the optical lens accessory is attached to the adapted terminal device, the first distance is such that an area associated with a portion of the viewing-angle-covered field blocked by the terminal device is minimized.
